(19) United States
(12) Patent Application Publication
(10) Pub. No.: US 2026/0095228 A1
(43) Pub. Date: Apr. 2, 2026

(54) SIMULTANEOUS EXCITATION FOR ANTENNA ARRAY DECORRELATION

(71) Applicant: QUALCOMM Incorporated, San Diego, CA (US)

(72) Inventors: Prasidh Ramabadran, Reading (GB); Tejinder Dip Singh, Bangalore (IN); Madhav Venkateswaran, Hyderabad (IN); Srinivas Pachava, Hyderabad (IN); Saranyan Nagarajan, Hyderabad (IN)

(21) Appl. No.: 18/903,813

(22) Filed: Oct. 1, 2024

(51) Int. Cl. H04B 7/06

(52) U.S. Cl. CPC H04B 7/0634; H04B 7/0663

(57) ABSTRACT

This disclosure provides systems, methods, and devices for wireless communications that support operation with an antenna array, such as multiple-in-multiple-out (MIMO) and/or beamforming. In a first aspect, a method for wireless communications includes exciting elements of an antenna array simultaneously using a plurality of encoded signals; determining a correlation matrix indicating a response of the antenna array based on responses of the elements of the antenna array captured during simultaneous excitation of the antenna array; and transmitting signals from at least some elements of the antenna array simultaneously based on the correlation matrix. Other aspects and features are also claimed and described.

### TECHNICAL FIELD

Aspects of the present disclosure relate generally to wireless communication systems, and more particularly, to radio frequency (RF) processing circuitry for wireless communication systems. Some features may enable and provide improved communications, including improved operation of RF transceivers, such as improved decoupling of elements in an antenna array by determination of a correlation matrix during simultaneous excitation of the elements.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

Modern wireless communication networks are sophisticated networks that involve operation on multiple frequencies and multiple frequency ranges. RF signals in different frequencies and ranges may use different components or different configurations of components to support a device operating on these wireless communication networks and maintain high signal integrity and high bandwidth across a range of possible network conditions. The duplication of components and number of supported configurations presents challenges in designing RF systems for the UEs and BSs operating on wireless communication networks.

In addition to multiple frequencies and ranges, communications equipment may include large arrays of antennas for transmitting signals on these frequencies and ranges. In an antenna array, correlation of elements, referring to the signal at one element affecting the signal at another element, can degrade performance. One conventional technique for reducing the impact of correlation between elements is to sequentially transmit calibration signals from the elements and measure the effect of that transmitted calibration signal on each of the other elements.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The conventional technique of sequentially transmitting a calibration signal from an element and measuring the signal at the other elements has disadvantages. For example, the sequential transmission of calibration signals from elements causes the length of the calibration process to increase exponentially as the number of elements in the antenna array increases. An increase in N elements in the array causes an increase of N calibration transmissions and N² calibration measurements. Additionally, the sequential transmission of calibration signals from individual elements does not fully capture the correlation between elements because, during normal operation, the elements are not operated individually. Thus, the sequential calibration does not capture load-pulling of power amplifiers coupled to each element as only one transmitter is excited at an instant during the calibration.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

In some aspects, the calibration of the antenna array to determine correlation between the elements includes simultaneous transmission of calibration signals through the elements. In this manner, the calibration more accurately reflects the operation of the antenna array during normal transmission and reception with wireless communication devices. A correlation matrix may be determined based on responses of the elements captured during the simultaneous transmission in calibration. That correlation matrix reflects the correlation characteristics of the antenna array for each element with respect to other elements. In some embodiments, the correlation matrix accounts for correlation between each element with respect to each of the other elements. The correlation matrix may be used during normal operation, when the antenna array is used by a base station in communicating with wireless communication devices, to reduce the effects of correlation between the elements, thereby improving performance of the antenna array such as with higher throughput.

During calibration, the transmitted signal, sometimes referred to as a stimulus signal, for each individual element may be coded with a unique code for that element. The unique codes for each element may be orthogonal to other codes for stimulus signals transmitted in parallel through the elements of the antenna array. For example, calibration of N elements in an antenna array may include transmitting N stimulus signals with N different orthogonal spreading codes, such as used in code division multiple access (CDMA) communication systems. The responses of each element in the antenna array may be captured and processed to determine the effect of each element on other elements. When orthogonal codes are used for calibration signals transmitted from each element, the processing of each element's captured response can uniquely determine the effect of other elements on a particular element. The responses of individual elements to each other element's stimulus signal transmission may be captured at each element's coupler as a weighted vector sum of the feedback from the same element and that coupled from other elements. A correlation matrix may be used to represent the correlated responses.

During normal operation, transmission signals for each element may be adjusted based on the correlation matrix to reduce resulting correlation when the transmission signals are used to excite the individual elements. In some embodiments, an inverse of the correlation matrix may be computed and applied to the transmission signals to cancel the effect of the measured correlation between elements. In some embodiments, the correlation matrix may be used to select a subset of elements to be used to transmit signals, such as by selecting a subset of elements with the least correlation. In some embodiments, the correlation matrix is used to select a subset of elements and an inverse correlation matrix is applied to transmission signals for those subset of elements. Although application of the correlation matrix is described during transmission of signals after calibration, the correlation matrix may also be applied to received signals at the antenna array to improve reception through the antenna array by reducing correlation between elements.

In one aspect of the disclosure, a method for wireless communication includes exciting elements of an antenna array simultaneously using a plurality of encoded signals; determining a correlation matrix indicating a response of the antenna array based on responses of the elements of the antenna array captured during simultaneous excitation of the antenna array; and transmitting signals from at least some elements of the antenna array simultaneously based on the correlation matrix.

In an additional aspect of the disclosure, an apparatus includes at least one processor and a memory coupled to the at least one processor. The at least one processor is configured to perform operations including exciting elements of an antenna array simultaneously using a plurality of encoded signals; determining a correlation matrix indicating a response of the antenna array based on responses of the elements of the antenna array captured during simultaneous excitation of the antenna array; and transmitting signals from at least some elements of the antenna array simultaneously based on the correlation matrix.

In an additional aspect of the disclosure, an apparatus includes means for exciting elements of an antenna array simultaneously using a plurality of encoded signals; means for determining a correlation matrix indicating a response of the antenna array based on responses of the elements of the antenna array captured during simultaneous excitation of the antenna array; and means for transmitting signals from at least some elements of the antenna array simultaneously based on the correlation matrix.

In an additional aspect of the disclosure, a non-transitory computer-readable medium stores instructions that, when executed by a processor, cause the processor to perform operations. The operations include exciting elements of an antenna array simultaneously using a plurality of encoded signals; determining a correlation matrix indicating a response of the antenna array based on responses of the elements of the antenna array captured during simultaneous excitation of the antenna array; and transmitting signals from at least some elements of the antenna array simultaneously based on the correlation matrix.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3A is a block diagram illustrating an antenna array controlled according to a correlation matrix determined during simultaneous excitation according to sone or more aspects of the disclosure.

FIG. 3B is a block diagram illustrating circuitry for generating transmit signals and processing feedback receive signals from an antenna array controlled according to a correlation matrix determined during simultaneous excitation according to sone or more aspects of the disclosure.

FIG. 4 is a flow chart illustrating a method for operating an antenna array according to a correlation matrix determined during simultaneous excitation according to one or more aspects of the disclosure.

FIG. 5 is a block diagram of an example base station that supports operating an antenna array according to a correlation matrix determined during simultaneous excitation according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support wireless communications, including techniques for reducing the negative effects of correlation between elements in an antenna array. The correlation of the elements may be determined from a simultaneous excitation of the elements, with captured responses of the elements processed to determine a correlation matrix representing the correlation. The correlation matrix may be used during transmission or reception with the antenna array.

Particular implementations of the subject matter described in this disclosure may be implemented to realize one or more of the following potential advantages or benefits. In some aspects, the present disclosure provides techniques for improved operation of antenna arrays, such as in beamforming base stations, massive multiple-input-multiple-output (MIMO) systems, customer premises equipment, wireless backhaul equipment, RADAR, and automobile application. The calibration techniques, when applied to this situations and others involving antenna arrays, may improve wireless communication systems. For example, the simultaneous excitation of the elements in the antenna array reduces the amount of time involved in the calibration process, such as by operating elements in parallel rather than in sequential manner. As another example, the simultaneous excitation of the elements results in a more accurate correlation determination because the elements are operated in a similar manner to how the antenna array is operated in normal operation with multiple excited elements. Thus, the correlation matrix determined by simultaneous excitation is better able to reduce the effect of correlation between elements, resulting in improved performance of the wireless communication system such as to improve throughput. Higher throughput improves user experience by allowing faster data transfers, higher quality photos and videos downloaded in less time, streaming of higher quality videos, faster message transfer, and many other benefits.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems”may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

As used herein, a “radio frequency” signal is a signal having a frequency above baseband, which includes, in an example embodiment of a heterodyne receiver, intermediate frequency signals.

As used herein, an “intermediate frequency” signal is a RF signal that has been downconverted from another RF signal to a frequency that is above baseband, such as in an example embodiment of a heterodyne mmWave transceiver that receives a mmWave RF signal and downconverts the mmWave RF signal to a mmWave IF signal that is further processed, such as through further downconversion, to a lower frequency RF signal or a baseband signal.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

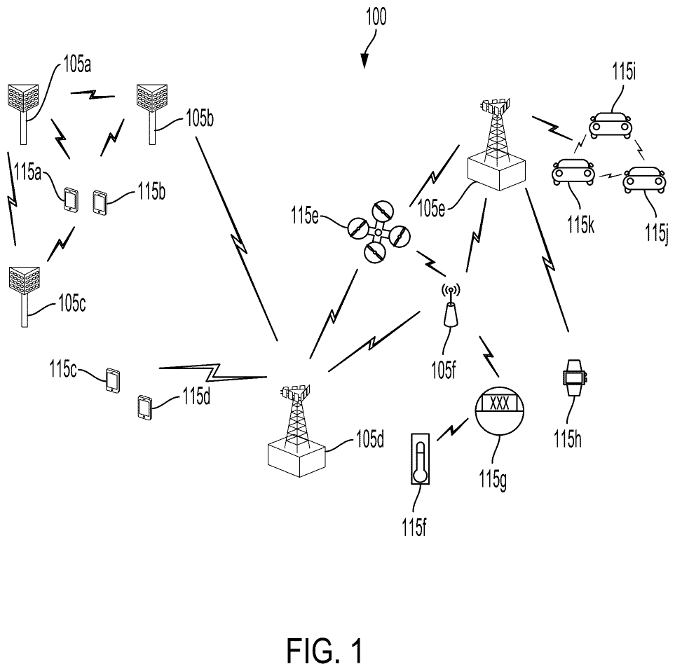

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

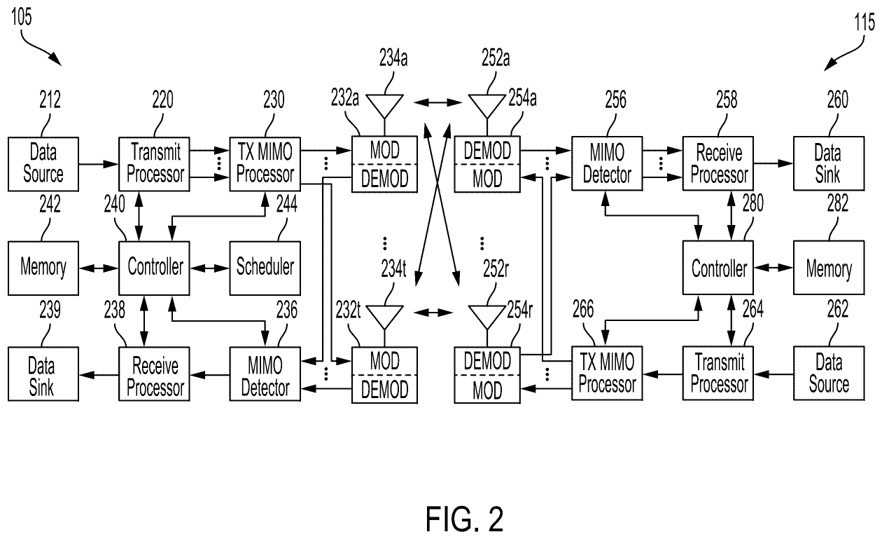

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

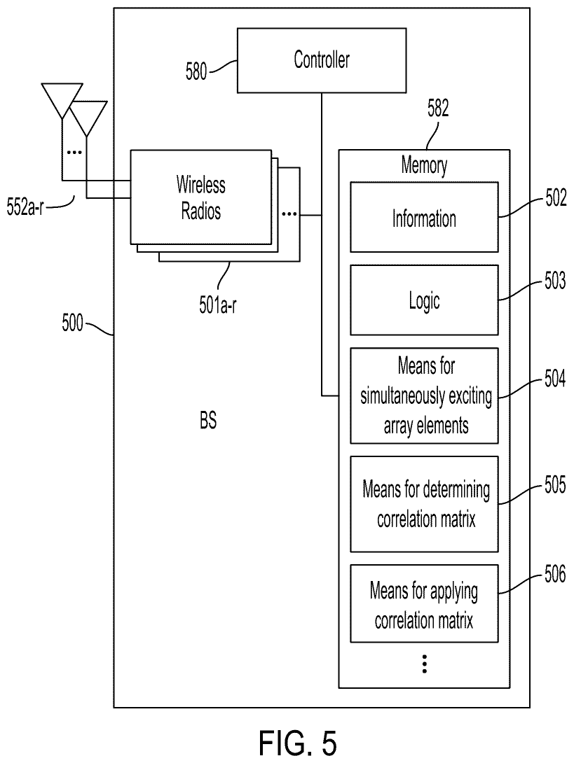

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIG. 5 or FIG. 6, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

The wireless communication systems described above with reference to FIG. 1 and FIG. 2 may include devices with antenna arrays. For example, the UE 115 may include an antenna array to support MIMO operations. As another example, the BS 105 may include an antenna array to support beamforming and/or MIMO operations. Any of the devices in a wireless communication system, such as UE 115 or BS 105, including an antenna array may implement simultaneous excitation of elements in the antenna array during calibration according to any of the embodiments described herein.

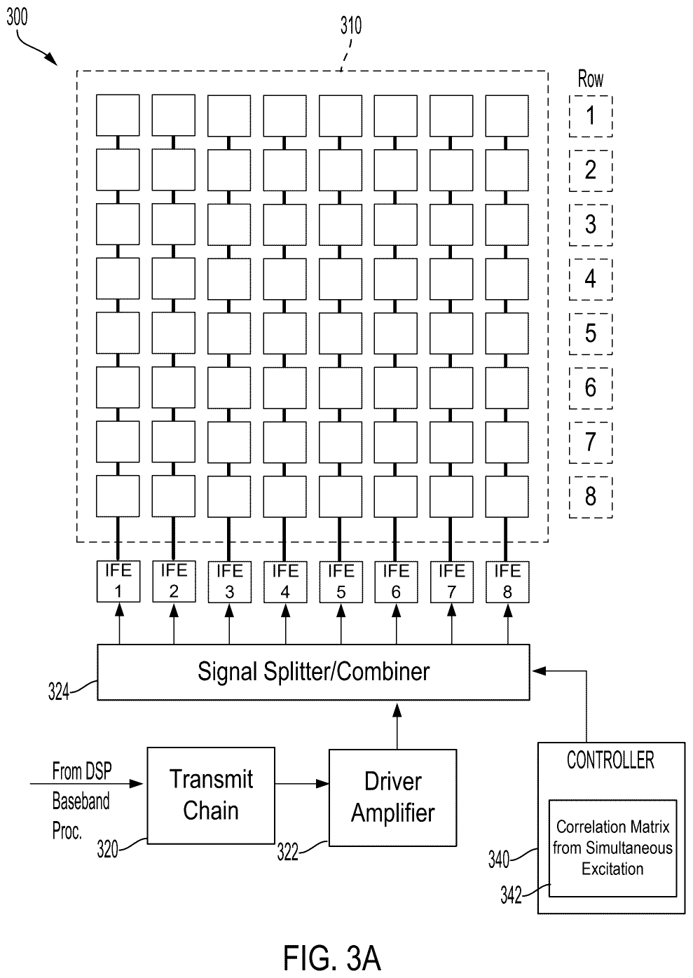

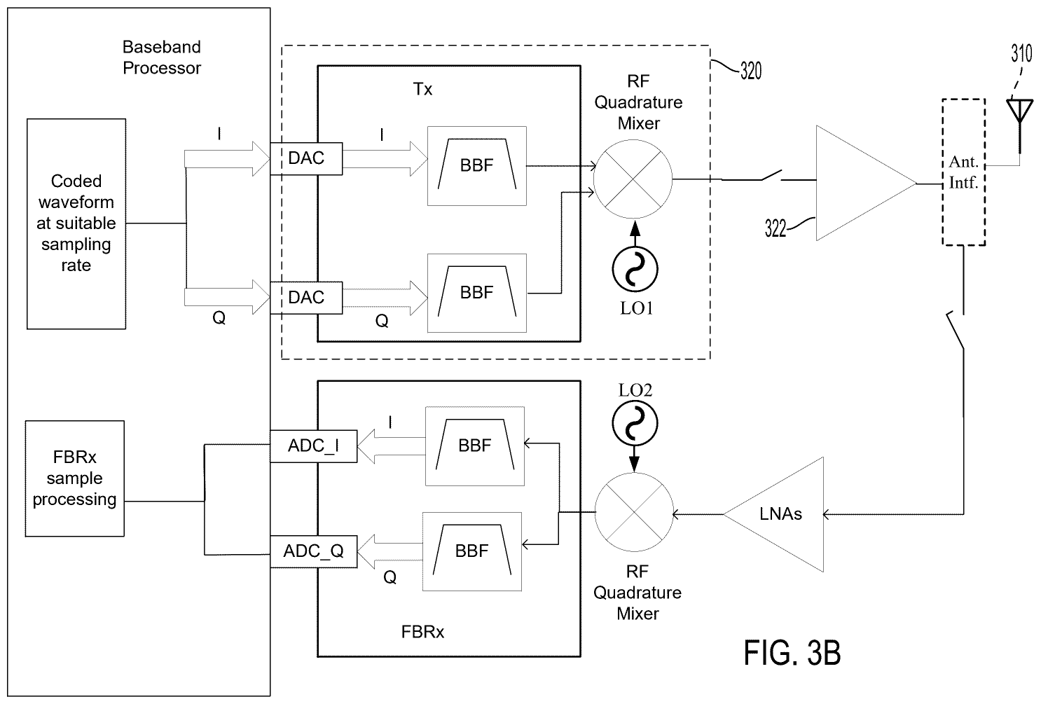

FIG. 3A is a block diagram illustrating an antenna array controlled according to a correlation matrix determined during simultaneous excitation according to some embodiments of the disclosure. A wireless communication device 300 may include an antenna array 310 with N rows and M columns. The example antenna array 310 is shown as an 8×8 array of elements, although other antenna arrays implementing aspects of this disclosure may have different number of elements in a different arrangement. Each group (e.g., column) of elements may be coupled to a front-end (e.g., IFE1-IFE8). The signal at each element may be determined from a signal splitter/combiner 324. When transmitting, the signal splitter/combiner 324 may receive a signal from a transmit path and split the signal across multiple elements of the array 310. When receiving, the signal splitter/combiner 324 may receive signals from the elements of the array 310 and combine the signals for processing. An example transmit path is shown in the transmit chain 320 and the driver amplifier 322 coupled to the signal splitter/combiner 324. A digital signal processor (DSP) or other processor or circuit provides data to the transmit chain 320, which generates transmit signals for conveying the data to a recipient, and the driver amplifier 322 amplifies the transmit signals to provide sufficient power to excite the elements of the antenna array 310.

The transmit chain 320 may include components to support sub-6 Ghz and/or mmWave radio frequency (RF) components. In some embodiments, portions or all of the components shown may be located in a single integrated circuit (IC) sharing a common substrate. The transmit chain 320 may include, for example, duplexers, SAW filters, switches, upconverters, and/or other transmit or receive circuits for conditioning signals for transmission. In some embodiments, the transmit chain 320 may include separate circuits for conditioning or otherwise processing sub-6 GHz signals, mmWave signals, satellite signals, and/or other signals.

In some embodiments, the transmit path and antenna array 310 may support carrier aggregation (CA) operation. Carrier aggregation (CA) involves the combination of one or more carrier RF signals to carry a single data stream. Carrier aggregation (CA) improves the flexibility of the wireless devices and improves network utilization by allowing devices to be assigned different numbers of carriers for different periods of time based, at least in part, on historical, instantaneous, and/or predicted bandwidth use by the wireless device. Thus, when a mobile device needs additional bandwidth, additional carriers may be assigned to that wireless device, and then de-assigned and re-assigned to other mobile devices when bandwidth demands change.

The controller 340 may be coupled to the signal splitter/combiner 324 to control the adjustment of signals provided to individual elements of the antenna array 310. For example, transmit signals from the transmit path, including the transmit chain 320 and the driver amplifier 322, may be adjusted in the signal splitter/combiner 324 by applying a correlation matrix to the signals. The controller 340 may control the signal splitter/combiner 324 according to a correlation matrix 342 determined from simultaneous excitation of the elements. Although the controller 340 and signal splitter/combiner 324 are described as applying the correlation matrix 342, the correlation matrix may be applied through other components of a transmit path, such as components in the transmit chain 320 and/or the processor that provides the data for transmission. The functionality of the controller 340 may be performed by any processor, including a generic central processing unit (CPU), a numerical co-processor, or an application-specific integrated circuit (ASIC).

A more details view of circuitry for transmission and feedback processing as part of the operation of an antenna array is shown in FIG. 3B. FIG. 3B is a block diagram illustrating circuitry for generating transmit signals and processing feedback receive signals from an antenna array controlled according to a correlation matrix determined during simultaneous excitation according to sone or more aspects of the disclosure. In some embodiments, the system may operate by setting the antenna switch to a receive (Rx) mode in the listening paths and use a receiver or feedback receiver (FBRx) to evaluate the coupling factors based on feedback captured from the antenna array 310. In other embodiments, the system may include directional couplers for coupling the transmit and receive paths to the antenna array 310.

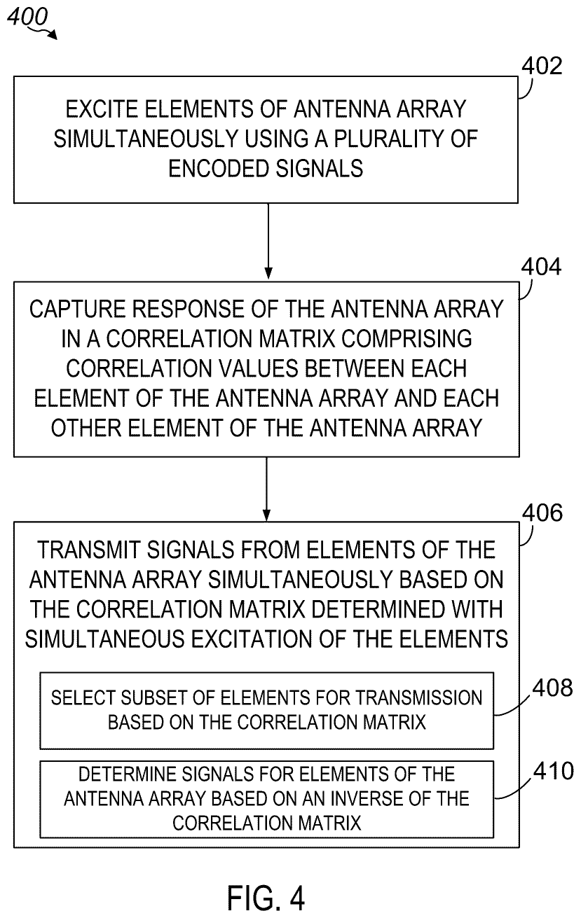

The determination and application of the correlation matrix 342 may be performed by portions of the method described with reference to the flow chart of FIG. 4. FIG. 4 is a flow chart illustrating a method for operating an antenna array according to a correlation matrix determined during simultaneous excitation according to one or more aspects of the disclosure. A method 400 includes a calibration operation at blocks 402 and 404 to determine a correlation matrix and normal operation at block 406 to apply the correlation matrix.

At block 402, elements of an antenna array are simultaneously excited using a plurality of encoded signals. Each of the elements may be excited with a unique stimulus signal. The stimulus signal is composed of a code unique to a specific element that is orthogonal to the codes used for the other elements. Thus, an antenna array with N elements will use N orthogonal spreading codes, as in a CDMA system. In some embodiments, the simultaneous excitations are of different encoding signals unique to each path between any two elements of the antenna array, such as with a unique and orthogonal code to uniquely distinguish the mutual coupling between these two elements (e.g., a NxN encoding matrix). In one example, exciting elements of the antenna array simultaneously at block 402 includes exciting elements of the antenna array with a plurality of stimulus signals and a plurality of receiver paths, with each receive path receiving a weighted response from each of the plurality of stimulus signals, each of the plurality of stimulus signals coded orthogonal to each of the other plurality of stimulus signals, which is used to distinguish each path uniquely in the weighted responses.

At block 404, responses of each element in the antenna array are captured and used to determine a correlation matrix comprising correlation values between each element of the antenna array and each other element of the antenna array. The responses are recorded while the elements are simultaneously excited, such that the recorded responses include the effect that each element has on each other element. The response captured at each element may be a weighted vector sum of the signals fed back from the same path and that coupled from the other paths. The captured responses are effectively a weighted sum of orthogonal codes. The responses may be demodulated using each of the N codes corresponding to each element. In some embodiments, the demodulation may be limited to the codes for neighboring elements (e.g., immediately adjacent and/or first alternate). A ratio may be determined of the demodulated baseband vectors using the element's own code to that demodulated using the code of the other elements to determine the coupling factors. The coupling factors may then be arranged in the form of an NxN matrix, in which N reflects the size of the antenna array. In one example, determining the correlation matrix comprises, for each element of the correlation matrix, determining a ratio of demodulated baseband vectors between a first element and a second element of the antenna array demodulated using a unique code to identify the coupling from for the first transmit element to the second receive element.

Although the determination of block 404 may involve the responses captured during simultaneous excitation of block 402, the determination of block 404 may not be performed simultaneously with the excitation of block 402. For example, the responses may be captured during simultaneous excitation and later processed to determine correlation values. In some embodiments, the captured responses may be transmitted to a remote processing device in the cloud for determining the correlation values and/or correlation matrix, which is then returned to the wireless communication device for use at block 406.

At block 406, signals may be transmitted from elements of the antenna array simultaneously based on the correlation matrix determined at block 404 during simultaneous excitation of the elements at block 402. For example, the method may include deriving the extent of mutual coupling between various antenna array elements based on the correlation matrix and modifying the transmitted signals to account for the mutual coupling. The transmitting of signals may include, in one example, determining a subset of elements of the antenna array based on the correlation matrix; determining an inverse correlation matrix based on the correlation matrix; and applying the inverse correlation matrix to a plurality of output signals to uniquely compute the mutual coupling including the effects of load pulling between any 2 elements from the subset of elements.

In one embodiment, the correlation matrix may be used at block 408 to select a subset of elements for use in transmitting signals. For example, a threshold correlation value may be selected and applied to the correlation matrix to choose elements exhibiting correlation below the threshold correlation value. As another example, a number of elements may be determined and the correlation matrix used to identify that number of elements that have the lowest correlations.

In another embodiment, the correlation matrix may be used at block 410 to determine signals for elements of the antenna array based on an inverse of the correlation matrix. The inverse correlation matrix applied to the transmit signals may compensate for correlation between the elements to improve performance of the antenna array despite any underlying correlation.

In some embodiments, transmission at block 406 may include both a selection at block 408 and inverse operations at block 410 based on the correlation matrix. For example, a subset of elements may be selected and an inverse correlation matrix determined for that subset of elements. As another example, if a numerically-stable inverse of the correlation matrix exists, the data to be transmitted can be shaped using the inverse correlation matrix, otherwise, as a tradeoff, some of the elements can be ignored, effectively reducing the maximum possible rank of the channel.

In any of these embodiments, cross-coupling is reduced to improve performance of the antenna array and thus increase bandwidth when the base station is communicating with user devices. Cross-coupling can be caused by, for example, surface waves propagating within an antenna substrate shared by multiple elements and/or signal effects in a power amplifier shared by multiple elements or in a power amplifier for the array coupled to other power amplifiers for the array. Operations in method 400 allow determining the mathematical correlation between the elements, which may be expressed as a correlation matrix, such that this correlation matrix identifies the cross-coupling. The correlation matrix may then be used to identify elements with high cross-coupling that reduces antenna performance, such that certain elements may be disabled to improve performance and/or signal processing be applied to transmission signals to reduce the effects of cross-coupling.

Although application of the correlation matrix is described during transmission of signals after calibration, the correlation matrix may also be applied to received signals at the antenna array to improve reception through the antenna array by reducing correlation between elements. Further, in some embodiments, the calibration process, one example of which is described with reference to blocks 402 and 404, may be repeated in response to the detection of certain events, may be repeated at scheduled times, and/or may be repeated at regular intervals. Each calibration may update the correlation matrix.

Operations of method 400 may be performed by a BS, such as BS 105 described above with reference to FIG. 1 or FIG. 2, or BS 500 described with reference to FIG. 5. For example, example operations (also referred to as “blocks”) of method 400 may enable BS 105 or BS 500 to support simultaneous excitation of elements in an antenna array using or to obtain a correlation matrix.

FIG. 5 is a block diagram of an example base station that supports operating an antenna array according to a correlation matrix determined during simultaneous excitation according to one or more aspects of the disclosure. Base station 500 may be configured to perform operations, including the blocks of method 400 described with reference to FIG. 4. In some implementations, base station 500 includes the structure, hardware, and components shown and described with reference to base station 105 of FIG. 1 or FIG. 2. For example, base station 500 may include controller 240, which operates to execute logic or computer instructions stored in memory 242, as well as controlling the components of base station 500 that provide the features and functionality of base station 500. Base station 500, under control of controller 240, transmits and receives signals via wireless radios 501a-t and antennas 534a-t. Wireless radios 501a-t include various components and hardware, as illustrated in FIG. 2 for base station 105, including modulator and demodulators 232a-t, transmit processor 220, TX MIMO processor 230, MIMO detector 236, and receive processor 238.

As shown, memory 582 may include information 502, logic 503, means for simultaneously exciting array elements 504, means for determining a correlation matrix for the antenna array 505, and/or means for applying the correlation matrix when operating antenna array 506. Information 502 may include, for example, the correlation matrix. Logic 503 may be configured to process the information 502 and/or to update the information 502.

Means for simultaneously exciting array elements 504 may include, for example, a signal splitter/combiner and/or a processor executing logic to control the splitter/combiner to cause the excitation of the array elements with orthogonally-coded signals. Means for determining a correlation matrix for the antenna array 505 may include, for example, a processor executing logic to decode captured responses from the elements during simultaneous excitation of the antennas and determine a correlation matrix. Means for applying the correlation matrix when operating antenna array 506 may include, for example, a signal splitter/combiner and/or a processor executing logic to control the splitter/combiner to apply the correlation matrix when transmitting/receiving signals to reduce or eliminate the effect of correlation between elements. Base station 500 may receive signals from or transmit signals to one or more UEs, such as UE 115 of FIG. 1 or FIG. 2.

In one or more aspects, techniques for supporting wireless communications, such as through an antenna array, may include additional aspects, such as any single aspect or any combination of aspects described below or in connection with one or more other processes or devices described elsewhere herein. In a first aspect, supporting wireless communication may include an apparatus with an antenna array with at least one processor coupled to the antenna array and configured to perform a series of operations (such as steps of a method) to calibrate the antenna array and operate the antenna array in accordance with information captured during calibration of the antenna array. Additionally, the apparatus may perform or operate according to one or more aspects as described below. In some implementations, the apparatus includes a wireless device, such as a UE or a base station (BS). In some implementations, the apparatus may include at least one processor, and a memory coupled to the processor. The processor may be configured to perform operations described herein with respect to the apparatus, including operations described herein with respect to methods of operating a wireless device. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a first aspect, supporting wireless communication may include an apparatus with a memory storing processor-readable code and at least one processor coupled to the memory, the at least one processor configured to execute the processor-readable code to cause the at least one processor to perform operations. The operations may include exciting elements of an antenna array simultaneously using a plurality of encoded signals; determining a correlation matrix indicating a response of the antenna array based on responses of the elements of the antenna array captured during simultaneous excitation of the antenna array; and transmitting signals from at least some elements of the antenna array simultaneously based on the correlation matrix.

In a second aspect, in combination with the first aspect, exciting elements of the antenna array simultaneously comprises exciting elements of the antenna array with a plurality of stimulus signals, each of the plurality of stimulus signals coded orthogonal to each of the other plurality of stimulus signals.

In a third aspect, in combination with one or more of the first aspect or the second aspect, determining the correlation matrix comprises, for each element of the correlation matrix, determining a ratio of demodulated baseband vectors between a first element and a second element of the antenna array demodulated using a code for the first element.

In a fourth aspect, in combination with one or more of the first aspect through the third aspect, transmitting signals based on the correlation matrix comprises determining an inverse correlation matrix based on the correlation matrix; and applying the inverse correlation matrix to a plurality of output signals to determine the signals for transmitting from at least some elements of the antenna array.

In a fifth aspect, in combination with one or more of the first aspect through the fourth aspect, transmitting signals based on the correlation matrix comprises determining a subset of elements of the antenna array based on the correlation matrix; and transmitting the signals using the subset of elements determined based on the correlation matrix.

In a sixth aspect, in combination with one or more of the first aspect through the fifth aspect, transmitting signals based on the correlation matrix comprises determining a subset of elements of the antenna array based on the correlation matrix; determining an inverse correlation matrix based on the correlation matrix; and applying the inverse correlation matrix to a plurality of output signals to determine the signals for transmitting from the subset of elements.

In a seventh aspect, in combination with one or more of the first aspect through the sixth aspect, the apparatus further includes an antenna array coupled to the at least one processor, the antenna array comprising a plurality of elements.

In an eighth aspect, in combination with one or more of the first aspect through the seventh aspect, a method of wireless communications includes exciting elements of an antenna array simultaneously using a plurality of encoded signals; determining a correlation matrix indicating a response of the antenna array based on responses of the elements of the antenna array captured during simultaneous excitation of the antenna array; and transmitting signals from at least some elements of the antenna array simultaneously based on the correlation matrix.

In a ninth aspect, in combination with one or more of the first aspect through the eighth aspect, exciting elements of the antenna array simultaneously comprises exciting elements of the antenna array with a plurality of stimulus signals, each of the plurality of stimulus signals coded orthogonal to each of the other plurality of stimulus signals.

In a tenth aspect, in combination with one or more of the first aspect through the ninth aspect, determining the correlation matrix comprises, for each element of the correlation matrix, determining a ratio of demodulated baseband vectors between a first element and a second element of the antenna array demodulated using a code for the first element.

In an eleventh aspect, in combination with one or more of the first aspect through the tenth aspect, transmitting signals based on the correlation matrix comprises determining an inverse correlation matrix based on the correlation matrix; and applying the inverse correlation matrix to a plurality of output signals to determine the signals for transmitting from at least some elements of the antenna array.

In a twelfth aspect, in combination with one or more of the first aspect through the eleventh aspect, transmitting signals based on the correlation matrix comprises determining a subset of elements of the antenna array based on the correlation matrix; and transmitting the signals using the subset of elements determined based on the correlation matrix.

In a thirteenth aspect, in combination with one or more of the first aspect through the twelfth aspect, transmitting signals based on the correlation matrix comprises determining a subset of elements of the antenna array based on the correlation matrix; determining an inverse correlation matrix based on the correlation matrix; and applying the inverse correlation matrix to a plurality of output signals to determine the signals for transmitting from the subset of elements.

In a fourteenth aspect, in combination with one or more of the first aspect through the thirteenth aspect, the method may be performed by at least one processor coupled to an antenna array, the antenna array comprising a plurality of elements.

In a fifteenth aspect, in combination with one or more of the first aspect through the fourteenth aspect, a base station includes an antenna array comprising a plurality of elements; a memory storing processor-readable code; and at least one processor coupled to the memory and coupled to the antenna array, the at least one processor configured to execute the processor-readable code to cause the at least one processor to cause excitation of at least some of the plurality of elements of the antenna array by performing operations including exciting elements of an antenna array simultaneously using a plurality of encoded signals; determining a correlation matrix indicating a response of the antenna array based on responses of the elements of the antenna array captured during simultaneous excitation of the antenna array; and transmitting signals from at least some elements of the antenna array simultaneously based on the correlation matrix.

In a sixteenth aspect, in combination with one or more of the first aspect through the fifteenth aspect, exciting elements of the antenna array simultaneously comprises exciting elements of the antenna array with a plurality of stimulus signals, each of the plurality of stimulus signals coded orthogonal to each of the other plurality of stimulus signals.

In a seventeenth aspect, in combination with one or more of the first aspect through the sixteenth aspect, determining the correlation matrix comprises, for each element of the correlation matrix, determining a ratio of demodulated baseband vectors between a first element and a second element of the antenna array demodulated using a code for the first element.

In an eighteenth aspect, in combination with one or more of the first aspect through the seventeenth aspect, transmitting signals based on the correlation matrix comprises determining an inverse correlation matrix based on the correlation matrix; and applying the inverse correlation matrix to a plurality of output signals to determine the signals for transmitting from at least some elements of the antenna array.

In a nineteenth aspect, in combination with one or more of the first aspect through the eighteenth aspect, transmitting signals based on the correlation matrix comprises determining a subset of elements of the antenna array based on the correlation matrix; and transmitting the signals using the subset of elements determined based on the correlation matrix.

In a twentieth aspect, in combination with one or more of the first aspect through the nineteenth aspect, transmitting signals based on the correlation matrix comprises determining a subset of elements of the antenna array based on the correlation matrix; determining an inverse correlation matrix based on the correlation matrix; and applying the inverse correlation matrix to a plurality of output signals to determine the signals for transmitting from the subset of elements.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-5 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 3 and 4 may be combined with one or more blocks (or operations) described with reference to another of the figures. For example, one or more blocks (or operations) of FIG. 3 may be combined with one or more blocks (or operations) of FIG. 1. As another example, one or more blocks associated with FIG. 4 may be combined with one or more blocks (or operations) associated with FIG. 1. Additionally, or alternatively, one or more operations described above with reference to FIGS. 1-4 may be combined with one or more operations described with reference to FIG. 5.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus, comprising:
a memory storing processor-readable code; and
at least one processor coupled to the memory, the at least one processor configured to execute the processor-readable code to cause the at least one processor to perform operations including:
exciting elements of an antenna array simultaneously using a plurality of encoded signals;
determining a correlation matrix indicating a response of the antenna array based on responses of the elements of the antenna array captured during simultaneous excitation of the antenna array; and
transmitting signals from at least some elements of the antenna array simultaneously based on the correlation matrix.

2. The apparatus of claim 1, wherein the plurality of encoded signals are orthogonal to each of the other plurality of encoded signals.

3. The apparatus of claim 2, wherein determining the correlation matrix comprises, for each element of the correlation matrix, determining a ratio of demodulated baseband vectors between a first element and a second element of the antenna array demodulated using a code for the first element.

4. The apparatus of claim 1, wherein transmitting signals based on the correlation matrix comprises:
determining an inverse correlation matrix based on the correlation matrix; and
applying the inverse correlation matrix to a plurality of output signals to determine the signals for transmitting from at least some elements of the antenna array.

5. The apparatus of claim 1, wherein transmitting signals based on the correlation matrix comprises:
determining a subset of elements of the antenna array based on the correlation matrix; and
transmitting the signals using the subset of elements determined based on the correlation matrix.

6. The apparatus of claim 1, wherein transmitting signals based on the correlation matrix comprises:
determining a subset of elements of the antenna array based on the correlation matrix;
determining an inverse correlation matrix based on the correlation matrix; and
applying the inverse correlation matrix to a plurality of output signals to determine the signals for transmitting from the subset of elements.

7. The apparatus of claim 1, further comprising an antenna array coupled to the at least one processor, the antenna array comprising a plurality of elements.

8. A method, comprising:
exciting elements of an antenna array simultaneously using a plurality of encoded signals;
determining a correlation matrix indicating a response of the antenna array based on responses of the elements of the antenna array captured during simultaneous excitation of the antenna array; and
transmitting signals from at least some elements of the antenna array simultaneously based on the correlation matrix.

9. The method of claim 8, wherein exciting elements of the antenna array simultaneously comprises exciting elements of the antenna array with a plurality of encoded signals coded orthogonal to each of the other plurality of encoded signals.

10. The method of claim 9, wherein determining the correlation matrix comprises, for each element of the correlation matrix, determining a ratio of demodulated baseband vectors between a first element and a second element of the antenna array demodulated using a code for the first element.

11. The method of claim 8, wherein transmitting signals based on the correlation matrix comprises:
determining an inverse correlation matrix based on the correlation matrix; and
applying the inverse correlation matrix to a plurality of output signals to determine the signals for transmitting from at least some elements of the antenna array.

12. The method of claim 8, wherein transmitting signals based on the correlation matrix comprises:
determining a subset of elements of the antenna array based on the correlation matrix; and
transmitting the signals using the subset of elements determined based on the correlation matrix.

13. The method of claim 8, wherein transmitting signals based on the correlation matrix comprises:
determining a subset of elements of the antenna array based on the correlation matrix;
determining an inverse correlation matrix based on the correlation matrix; and
applying the inverse correlation matrix to a plurality of output signals to determine the signals for transmitting from the subset of elements.

14. The method of claim 8, wherein exciting elements of an antenna array simultaneously comprises generating the plurality of encoded signals by a baseband processor, wherein the plurality of encoded signals comprise I-channel and Q-channel signals.

15. A base station, comprising:
an antenna array comprising a plurality of elements;
a memory storing processor-readable code; and
at least one processor coupled to the memory and coupled to the antenna array, the at least one processor configured to execute the processor-readable code to cause the at least one processor to cause excitation of at least some of the plurality of elements of the antenna array by performing operations comprising:
exciting elements of an antenna array simultaneously using a plurality of encoded signals;
determining a correlation matrix indicating a response of the antenna array based on responses of the elements of the antenna array captured during simultaneous excitation of the antenna array; and
transmitting signals from at least some elements of the antenna array simultaneously based on the correlation matrix.

16. The base station of claim 15, wherein exciting elements of the antenna array simultaneously comprises exciting elements of the antenna array with a plurality of encoded signals coded orthogonal to each of the other plurality of encoded signals.

17. The base station of claim 16, wherein determining the correlation matrix comprises, for each element of the correlation matrix, determining a ratio of demodulated baseband vectors between a first element and a second element of the antenna array demodulated using a code for the first element.

18. The base station of claim 15, wherein transmitting signals based on the correlation matrix comprises:
determining an inverse correlation matrix based on the correlation matrix; and
applying the inverse correlation matrix to a plurality of output signals to determine the signals for transmitting from at least some elements of the antenna array.

19. The base station of claim 15, wherein transmitting signals based on the correlation matrix comprises:
determining a subset of elements of the antenna array based on the correlation matrix; and
transmitting the signals using the subset of elements determined based on the correlation matrix.

20. The base station of claim 15, wherein transmitting signals based on the correlation matrix comprises:
determining a subset of elements of the antenna array based on the correlation matrix;
determining an inverse correlation matrix based on the correlation matrix; and
applying the inverse correlation matrix to a plurality of output signals to determine the signals for transmitting from the subset of elements.
